(19) United States
(12) Patent Application Publication
(10) Pub. No.: US 2017/0099491 A1
(43) Pub. Date: Apr. 6, 2017

(54) APPARATUS, METHOD AND NON-TRANSITORY MEDIUM STORING PROGRAM FOR ENCODING MOVING PICTURE

(71) Applicant: FUJITSU LIMITED, Kawasaki-shi (JP)

(72) Inventors: Xuying LEI, Kawasaki (JP); Satoshi SHIMADA, Kawasaki (JP); Hidenobu MIYOSHI, Kawasaki (JP)

(73) Assignee: FUJITSU LIMITED, Kawasaki-shi (JP)

(21) Appl. No.: 15/272,715

(22) Filed: Sep. 22, 2016

(30) Foreign Application Priority Data
Oct. 1, 2015 (JP) 2015-196008

(51) Int. Cl. H04N 19/172; H04N 19/15; H04N 19/107; H04N 19/174; H04N 19/154

(52) U.S. Cl. CPC H04N 19/172; H04N 19/174; H04N 19/154; H04N 19/107; H04N 19/15

(57) ABSTRACT

An apparatus for encoding a moving picture data by an intra-refresh technique includes a memory, and a processor coupled to the memory. The apparatus performs setting of a width of an intra slice in each of a plurality of pictures included in the moving picture data within a refresh cycle having a given length such that a generated information amount in the intra slice is equalized between each of the plurality of pictures. The apparatus performs an intra-refresh to a region corresponding to the intra slice. The apparatus performs encoding of each block included in a refreshed region, through which the intra slice is passed in the refresh cycle, by referring to an encoded pixel in the refreshed region of the picture or in the refreshed region of an encoded picture whose encoding sequential order is before that of the picture.

### CROSS-REFERENCE TO RELATED APPLICATION

This application is based upon and claims the benefit of priority of the prior Japanese Patent Application No. 2015-196008, filed on Oct. 1, 2015, the entire contents of which are incorporated herein by reference.

### FIELD

The present disclosure generally relates to an apparatus, a method, and a non-transitory medium storing a program for encoding a moving picture data with an intra-refresh technique.

### BACKGROUND

Moving picture data generally has a very large amount of data. Accordingly, an apparatus handling such moving picture data encodes the moving picture data by using high-efficiency encoding before transmitting the moving picture data to another apparatus or before storing the moving picture data in a storage device. “High-efficiency encoding” refers to an encoding process that converts a certain data stream to another data stream and thereby compresses the amount of data.

As a high-efficiency encoding method of moving picture data, there has been known an intra-picture prediction (intra prediction) encoding method. The encoding method uses the fact that moving picture data has a high correlation between the spatially consecutive (or neighbouring) pixels included in the moving picture data and does not use encoding image of other pictures. Accordingly, the intra-picture prediction encoding method makes it possible to decode encoded picture based only on information within a picture.

Further, as the other encoding method adopted in the high-efficiency encoding method, there has also been known an inter-picture prediction (inter prediction) encoding method. This encoding method uses the fact that the moving picture data has a high correlation between the temporally consecutive picture data. In moving picture data, there is typically a higher similarity between picture data at a certain timing and picture data at the next timing. Therefore, the inter-picture prediction encoding method uses this characteristic of moving picture data. Generally, an apparatus for encoding a moving picture divides an encoding target current picture into a plurality of encoding blocks. The apparatus for encoding a moving picture selects, for each block, a region similar to an encoding block from a reference picture obtained by decoding an encoded picture as a reference region, and calculates a prediction error image indicating a difference between the reference region and the encoding block so as to remove redundancy in the time. Then, the apparatus for encoding a moving picture encodes motion vector information representing the reference region and the prediction error image to achieve a high compression rate. Generally, in the inter-picture prediction encoding method, compression efficiency is high as compared to an intra prediction encoding method.

As a typical encoding technique of the moving picture adopting these prediction encoding methods, moving picture experts group phase 2 (MPEG-2), MPEG-4, or H.264 MPEG-4 advanced video coding (H.264 MPEG-4 AVC) is widely used. In these encoding systems, for example, according to the picture, any one of the intra prediction encoding technique and the inter-picture prediction encoding method is selected, and a video stream including the encoded moving picture data will be explicitly described. The selected prediction encoding method is referred to as an “encoding mode”.

In a case where communication of the moving picture data which is encoded using such an encoding technique is performed in real time, in the apparatus for encoding a moving picture and an apparatus for decoding a moving picture, low delay has been achieved. As one method for implementing the low delay, it is considered that an information amount of each picture is equalized and a buffering delay is controlled. For obtaining the same image quality in each picture after decoding, it is preferable that variations in the encoding amount for each picture are reduced. However, generally, the encoding amount of the picture to which the intra prediction encoding mode is applied is greater than the encoding amount of the picture to which the inter prediction encoding mode is applied. Accordingly, when the encoding amount of the intra-picture (referred to as an “I picture”) to which the intra prediction encoding mode is applied is set to approximately equivalent to the encoding amount of the picture to which the inter prediction encoding mode is applied, the image quality of the intra-picture is considerably deteriorated. As a result, an image quality of the picture which is obtained such that the intra-picture is subjected to intra prediction encoding as a reference picture is also considerably deteriorated. As a result, the overall image quality of the moving picture data is greatly deteriorated.

As a method for the image quality of the decoded moving picture data from not being greatly deteriorated and for maintaining the encoding amount of each picture substantially, the intra-refresh technique (also, referred to as an intra slice technique) is proposed. In the intra-refresh technique, a picture other than a first picture of the moving picture data to be encoded is not set to an intra picture and a block group, which is subjected to intra prediction encoding, is inserted into each picture so as to travel in the picture at a given cycle. The intra encoded block group is referred to as an “intra slice”.

The intra-refresh technique will be described while referring to FIG. 1. FIG. 1 illustrates an example where the intra slice moves in a vertical direction. In FIG. 1, a horizontal axis indicates a time. Each of pictures 101 to 106 is encoded as a P picture in which the inter prediction encoding mode referring to only one direction is applicable or a B picture in which the inter prediction encoding mode in both directions referring to only a past picture is applicable. The apparatus for encoding a moving picture shifts the position of an intra slice 110, to which an intra refresh is applied, gradually downward for each picture. The apparatus for encoding a moving picture causes the intra slice 110 to travel overall pictures at a certain refresh cycle. For example, in FIG. 1, a refreshed region 111 through which the intra slice 110 is passed is extended downward with the lapse of time. In the refreshed region 111 (e.g. a region upside a refreshed boundary 112 which is a lower end of the intra slice 110), each block is encoded by referring to the refreshed region of the past encoded picture or the refreshed region of a present picture. As a result, after the intra slice is traveled one cycle, since overall pictures are refreshed, the apparatus for decoding a moving picture can restart the decoding from the refreshed picture, even when an error such as the picture may not be reproduced due to a transmission error occurs. In addition, the apparatus for decoding a moving picture can decode moving picture data from the middle. In this case, the apparatus for decoding a moving picture can normally decode from the picture obtained after a period, where the intra slice is traveled at one cycle for up to a time point of the start of encoding, (hereinafter, referred to as a refresh cycle) has elapsed. Furthermore, since the encoding amount increases in the picture excluding the first picture of the overall moving picture data, the intra picture may not be used. Accordingly, the size of a buffer in the apparatus for encoding a moving picture and the apparatus for decoding a moving picture may be small. As a result, the delay due to the buffering can be reduced.

However, the information amount generated for each picture (hereinafter, simply referred to as a “generated information amount”) is different in some cases depending on a subject in the picture. In general, for exhibiting approximately equal image quality of the decoded picture, the encoding amount increases as the picture in which the generated information amount increases. For suppressing the deterioration in the image quality due to a variation of the generated information amount, a technique, which predicts the generated information amount by the image motion of a video signal and changing a period where to being refreshed according to the prediction result and the width of the region where to being refreshed, is proposed. In addition, a technique which increases the region where an intra encoding block is applied while maintaining a target encoding amount, by setting a feature amount of the moving picture and a width of the region where the intra encoding block is applied from the target encoding amount, is proposed.

As examples of the related art, Japanese Laid-open Patent Publication No. H05-328330 and Japanese Laid-open Patent Publication No. 2011-233991 are known.

### SUMMARY

According to an aspect of the invention, an apparatus for encoding a moving picture data by an intra-refresh technique includes a memory, and a processor coupled to the memory. The apparatus performs setting of a width of an intra slice in each of a plurality of pictures included in the moving picture data within a refresh cycle having a given length such that a generated information amount in the intra slice is equalized between each of the plurality of pictures. The apparatus performs an intra-refresh to a region corresponding to the intra slice. The apparatus performs encoding of each block included in a refreshed region, through which the intra slice is passed in the refresh cycle, by referring to an encoded pixel in the refreshed region of the picture or in the refreshed region of an encoded picture whose encoding sequential order is before that of the picture.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of time-dependent changes in a refreshed region by an intra-refresh technique in a case where an intra slice moves in a vertical direction;

FIG. 2 is a schematic diagram illustrating an apparatus for encoding a moving picture according to a first embodiment;

FIG. 3 is an explanatory diagram of generated information amount estimation according to the first embodiment;

FIG. 4 is a flowchart of operation of an intra slice width setting process;

FIG. 5 is a diagram illustrating an example of the intra slice to be set in each picture in one refresh cycle, according to the first embodiment;

FIG. 6 is a diagram illustrating an example of a divided structure of a picture by HEVC;

FIG. 7 is a flowchart of operation of a moving picture encoding process according to the first embodiment;

FIG. 8 is a diagram illustrating an example of an intra slice set in each picture within one refresh cycle according to a second embodiment;

FIG. 9 is a flowchart of operation of a moving picture encoding process according to the second embodiment;

FIG. 10 is a diagram illustrating an example of an intra slice which is set in each picture within one refresh cycle according to a modification example;

FIG. 11 is a schematic configuration diagram of an apparatus for encoding a moving picture according to a third embodiment;

FIG. 12 is a diagram illustrating an example of an intra slice set in each picture within one refresh cycle according to a modification example;

FIG. 13 is a diagram illustrating an example of time-dependent changes in a refreshed region by the intra-refresh technique in a case where an intra slice moves in a horizontal direction; and

FIG. 14 is a configuration diagram of a computer operated as an apparatus for encoding a moving picture by operating a computer program for implementing the functionality of the various units of the apparatus for encoding a moving picture according to each embodiment or the modification examples thereof.

### DESCRIPTION OF EMBODIMENTS

In the related art, when a generated information amount of each picture increases, a width of an intra slice in a traveling direction of the intra slice in which a picture becomes small, thereby a refresh cycle increases. Therefore, in a case where the apparatus for decoding a moving picture reproduces moving picture data from the middle, a period until the moving picture data is ready for reproducing increases.

In addition, even in a case where a subject in the picture remains stationary (e.g. a position and a shape of the subject are not changed over a plurality of pictures), there are some cases where a generated information amount increases such as a case where a complicated pattern is included in the subject. With respect to the picture, in the technique disclosed in Japanese Laid-open Patent Publication No. 05-328330, since the width of the intra slice is increased, the generated information amount in the intra slice increases. As a result, for maintaining the encoding amount uniformly, it is desired to increase a quantization width to be applied with respect to each block within the intra slide. Accordingly, the image quality is deteriorated.

As one aspect of the present embodiment, provided are solutions for being able to perform: control of the variation of the generated information amount of the intra slide between the pictures while maintaining the refresh cycle uniformly.

Hereinafter, the apparatus for encoding a moving picture will be described with reference to accompanying drawings. The apparatus for encoding a moving picture adopts the intra-refresh technique. The apparatus for encoding a moving picture calculates an estimation value of the generated information amount for each block line which has a given width along the direction in which the intra slice travels based on a leading picture of the refresh cycle. The apparatus for encoding a moving picture calculates a target information amount of the intra slice in each picture by dividing a total sum of the estimation values of the generated information amount for each block line by the refresh cycle. The apparatus for encoding a moving picture maintains the refresh cycle constantly, and sets the width along the traveling direction of the intra slice so as to the generated information amount of the intra slice to be the target information amount.

Hereinafter, for convenience, the width of the intra slice along the traveling direction of the intra slice is simply referred to as an intra slice width. In addition, the traveling direction of the intra slice (e.g. a direction where the refresh boundary moves) is referred to as a refresh direction. In the present embodiments, the refresh direction is a vertical direction.

In addition, in the present embodiment, the apparatus for encoding a moving picture encodes each picture included in the moving picture data according to high efficiency video coding (HEVC). The apparatus for encoding a moving picture may follow other moving picture encoding standards in which an intra-refresh technique can be applied.

The picture may be any of a frame and a field. The frame is one still image in the moving picture data. On the other hand, the field is the still image obtained by extracting only data in an odd-numbered row or only data in an even-numbered row from the frame.

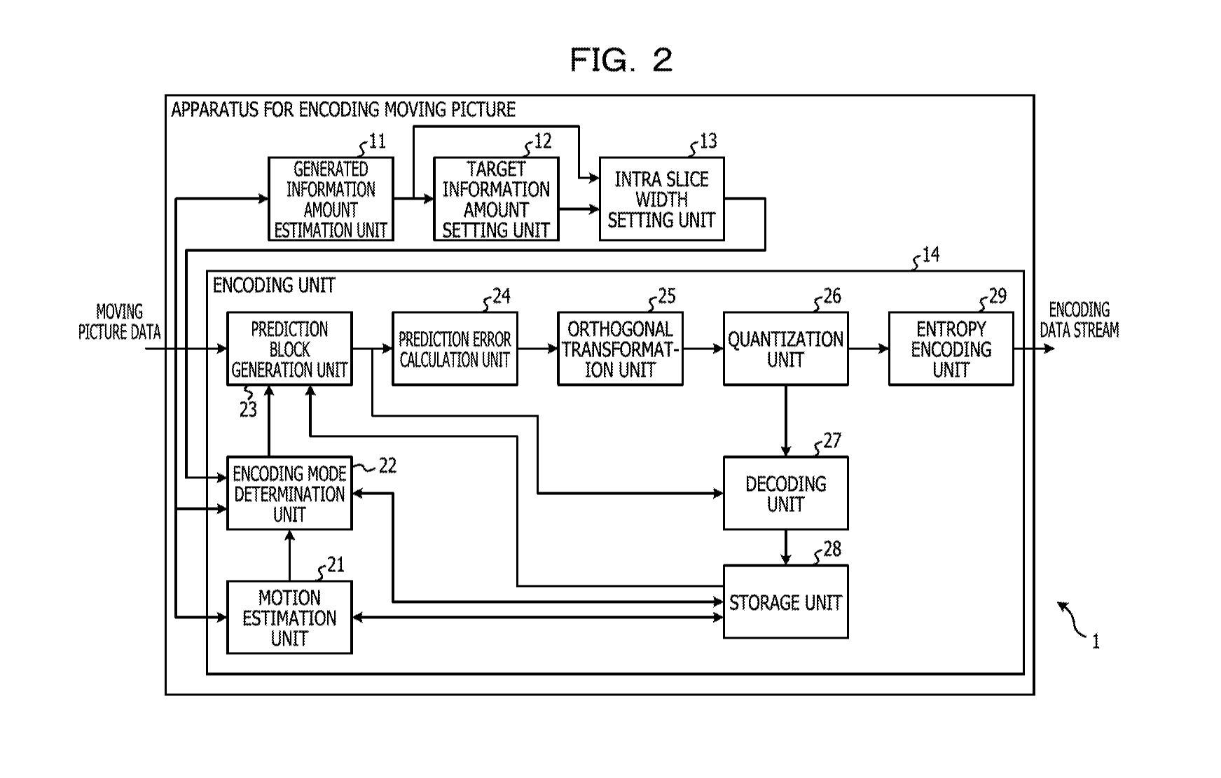

FIG. 2 is a schematic diagram illustrating the apparatus for encoding a moving picture according to a first embodiment. An apparatus for encoding a moving picture 1 includes a generated information amount estimation unit 11, a target information amount setting unit 12, an intra slice width setting unit 13, and an encoding unit 14. In addition, an encoding unit 14 includes a motion estimation unit 21, an encoding mode determination unit 22, a prediction block generation unit 23, a prediction error calculation unit 24, an orthogonal transformation unit 25, a quantization unit 26, a decoding unit 27, a storage unit 28, and an entropy encoding unit 29.

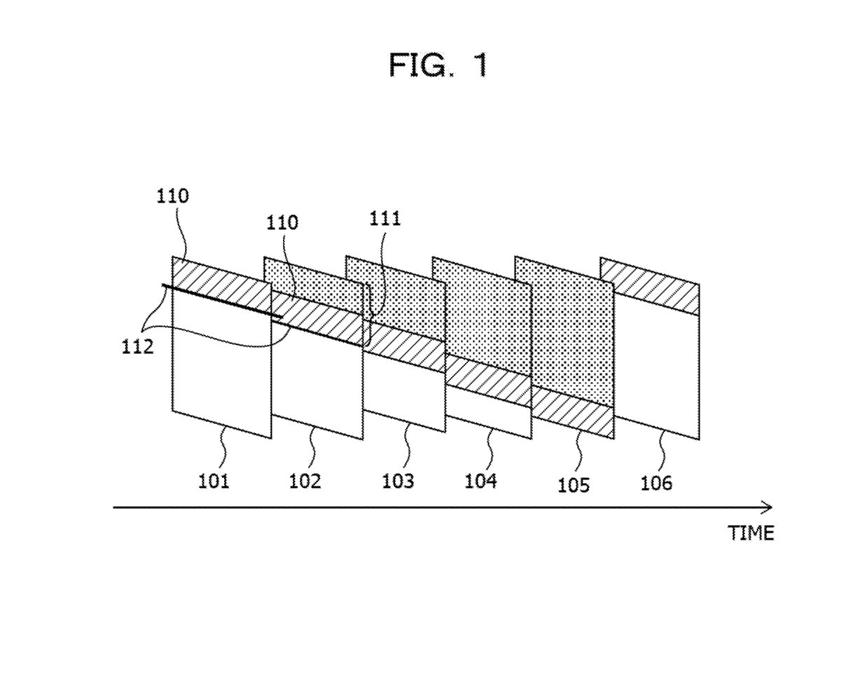

Each unit included in the apparatus for encoding a moving picture 1 is formed as a separate circuit, respectively. Alternatively, these units included in the apparatus for encoding a moving picture 1 may be mounted at the apparatus for encoding a moving picture 1 as a single or a plurality of integrated circuits in which a circuit corresponding to each unit is integrated. Furthermore, each unit included in the apparatus for encoding a moving picture 1 may be a functional module which is realized by a computer program which is executed on a processor included in the apparatus for encoding a moving picture 1. For example, by executing a computer program stored in a memory included in the apparatus for encoding a moving picture 1 on the processor, the processor included in the apparatus for encoding a moving picture 1 can be operated as a hardware circuit which can execute a part or overall process of each unit illustrated in FIG. 1.

The generated information amount estimation unit 11 calculates an estimation value of the generated information amount in a leading picture for each time when a leading picture of the refresh cycle having a certain length is input to the apparatus for encoding a moving picture 1. Hereinafter, the leading picture of the refresh cycle is simply referred to as a leading picture.

In the present embodiment, the generated information amount estimation unit 11 divides a leading picture by a plurality of block lines which have a given width along the refresh direction and extends in a direction perpendicular to the refresh boundary. The given width is set, for example, to a minimize size of the block to be a unit of the encoding process. Accordingly, the number of pixels from the upper end of the picture to the refresh boundary is an integer multiple of the given width. In the present embodiment, since the apparatus for encoding a moving picture 1 follows the HEVC, the number of pixels is set to 8 pixels that is a minimum size of a coding unit (CU) to be a unit to which the encoding mode is applied. However, the width of the block line is not limited to the 8 pixels, for example, may be set to 16 pixels or 32 pixels.

The generated information amount estimation unit 11 calculates distributions of luminance brightness values of each pixel included in a block line as the estimation value of the generated information amount of the block line, for each block line. The generated information amount estimation unit 11 calculates a total sum of the distributions of each of the block lines as the estimation value of the generated information amount of the leading picture.

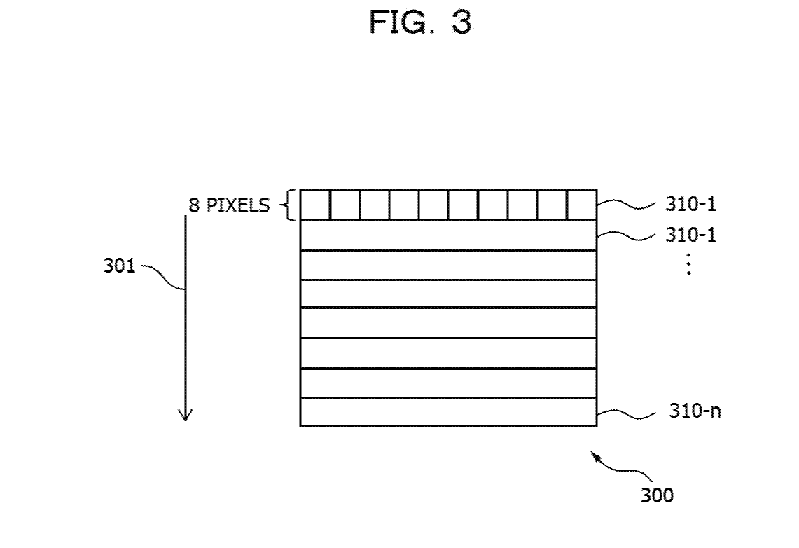

FIG. 3 is an explanatory diagram of generated information amount estimation according to the first embodiment. A leading picture 300 is divided by block lines 310-1 to 310-n (n is an integer equal to or greater than 2) which have a given width (in this example, 8 pixels) along a refresh direction 301 illustrated by an arrow. The distributions V1 to Vn of the luminance brightness that is the estimation value of the generated information amount is calculated for each of the block lines 310-1 to 310-n.

The generated information amount estimation unit 11 notifies the target information amount setting unit 12 of the estimation value of the generated information amount of the leading picture. In addition, the generated information amount estimation unit 11 notifies the intra slice width setting unit 13 of the estimation value of the generated information amount for each block line.

The target information amount setting unit 12 sets the target information amount that is a target value of the generated information amount of the intra slice, in each picture within the refresh cycle, based on the estimation value of the generated information amount of the leading picture and the refresh cycle.

In the intra-refresh technique, by limitation of the applicable encoding mode and the referable region, the encoding amount of the intra slice relatively increases as compared with the encoding amount of the other regions which have the same size in the picture. Therefore, for each picture within the refresh cycle, the width of the intra slice in each picture is set such that the generated information amounts of the intra slice are equalized. Accordingly, the variation of the encoding amount for each picture can be suppressed. The target information amount setting unit 12 sets the value obtained by dividing the estimation value of the generated information amounts of the leading picture to the target information amount such that the generated information amounts of the intra slice in each picture are equalized.

The target information amount setting unit 12 notifies the intra slice width setting unit 13 of the target information amount.

The intra slice width setting unit 13 sets the width of the intra slice such that the difference between the estimation value of the generated information amount of the intra slice of the picture and the target information amount is minimized, for each picture within the refresh cycle. In this time, the intra slice width setting unit 13 uses the estimation value of the generated information amount of the each block line of the leading picture as the estimation value of the generated information amount of the block line at a position same as that of the each picture within the same refresh cycle. The reason why the intra slice width setting unit 13 uses the estimation value is that in the moving picture data, a correlation between the temporally consecutive pictures is generally provided and there is a high possibility that the subject in a certain position of the leading picture is recognized similar to the subject in the same position of the other picture within the refresh cycle. Therefore, it is assumed that the difference between the generated information amount of the certain block line of the leading picture and the generated information amount of the block line in the same position as that of the other picture within the refresh cycle is small.

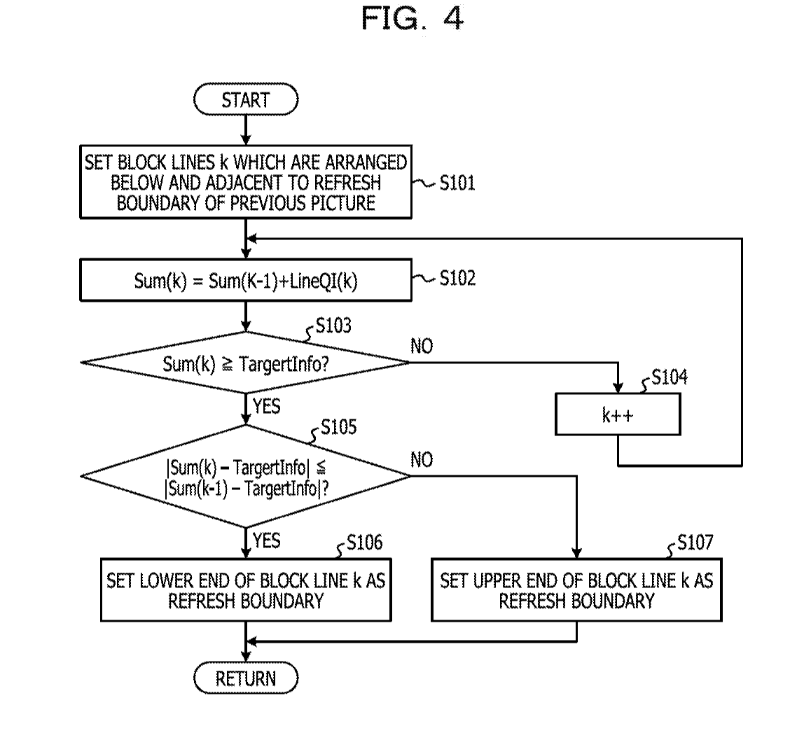

FIG. 4 is a flowchart of operation of an intra slice width setting process by the intra slice width setting unit 13. The intra slice width setting unit 13 sets the intra slice width according to the operation flow chart for each picture. However, regarding the picture that is last in the encoding sequence within the refresh cycle, since the lower end of the picture becomes the fresh boundary, the intra slice width setting process may be omitted.

The intra slice width setting unit 13 sets the block lines, which are arranged below and adjacent to the refresh boundary set in the previous picture in the encoding sequence, to a focusing block line k (step S101). The intra slice width setting unit 13 adds a estimation value LineQI(k) of the generated information amount in the focusing block line k to an accumulated sum Sum(k−1) of the generated information amount of the intra slice to calculate an accumulated sum Sum(k) after updating (step S102). The intra slice width setting unit 13 saves the accumulated sum Sum(k) to a memory included in the intra slice width setting unit 13. Furthermore, the intra slice width setting unit 13 saves the accumulated sum Sum(k−1) before updating to the memory as a past accumulated sum.

The intra slice width setting unit 13 determines whether the accumulated sum Sum(k) is equal to or more than a target information value TargetInfo (step S103). In a case where the accumulated sum Sum(k) is less than the target information value TargetInfo (step S103—No), the intra slice width setting unit 13 set the block lines which are arranged below and adjacent to the focusing block line to a next focusing block line (step S104). For example, the number k of the block line from the refresh boundary of the previous picture to the focusing block line is incremented by 1. The intra slice width setting unit 13 repeats processing of step S102 onward.

On the other hand, in a case where the accumulated sum Sum(k) is equal to or more than the target information value TargetInfo(step S103—Yes), the intra slice width setting unit 13 determines whether an absolute value of a difference between the accumulated sum Sum(k) and the target information value TargetInfo is equal to or less than an absolute value of a difference between the past accumulated sum Sum(k−1) and the target information value TargetInfo (step S105). In a case where the absolute value of the difference between the accumulated sum Sum(k) and the target information value TargetInfo is equal to or less than the absolute value of the difference between the past accumulated sum Sum(k−1) and the target information value TargetInfo (step S105—Yes), the intra slice width setting unit 13 set the lower end of the focusing block line k as the refresh boundary (step S106). On the other hand, in a case where the absolute value between the accumulated sum Sum(k) and the target information value TargetInfo is greater than the absolute value between the past accumulated sum Sum(k−1) and the target information value TargetInfo (step S105—No), the intra slice width setting unit 13 sets the upper end of the focusing block line k as the refresh boundary (step S107). After step S106 or S107, the intra slice width setting unit 13 terminates the intra slice width setting process. A region included between the refresh boundary which is set for the focusing picture and the refresh boundary of the previous picture in the encoding sequence becomes the intra slice for the focusing picture. For example, the number of pixels between the refresh boundary which is set for the focusing picture and the refresh boundary of the previous picture in the encoding sequence becomes a width of the intra slice of the focusing picture.

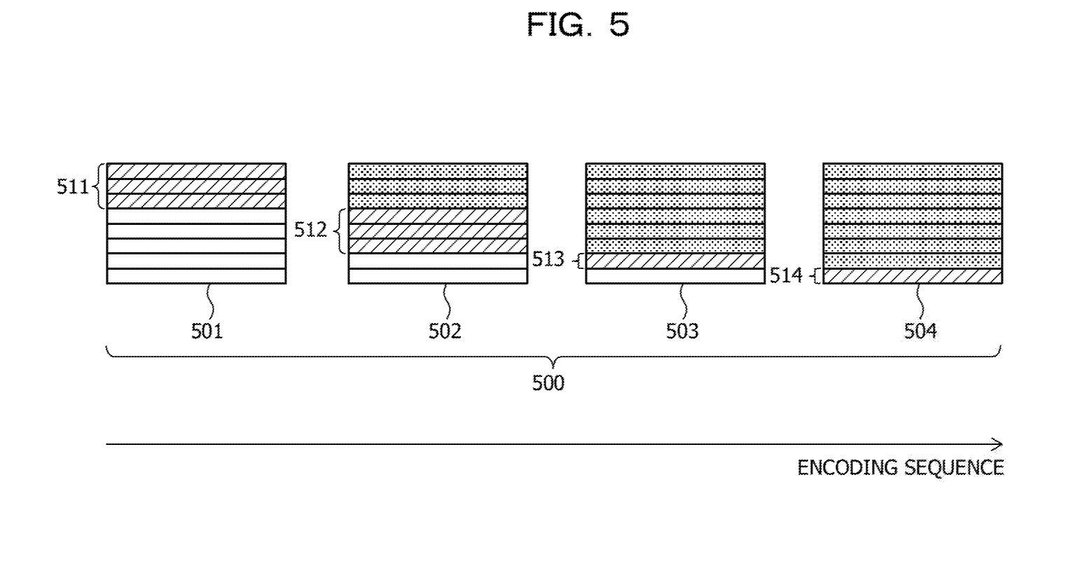

FIG. 5 is a diagram illustrating an example of the intra slice to be set in each picture in one refresh cycle, according to the present embodiment. In FIG. 5, the horizontal axis represents an encoding sequence. In this example, four pictures 501 to 504 are included within a refresh cycle 500 in an encoding order. For example, the refresh cycle is four. Each of intra slices 511 to 514 is set in each picture. In this example, the width of the intra slice 511 to be set in the picture 501 is identical to the width of the intra slice 512 to be set in the picture 502. In addition, the width of the intra slice 513 to be set in the picture 503 is identical to the width of the intra slice 514 to be set in the picture 504. On the other hand, the width of the intra slice 513 and the width of the intra slice 514 are less than the width of the intra slice 511 and the width of the intra slice 512.

The intra slice width setting unit 13 notifies the encoding unit 14 of a coordinate of the upper end (refresh boundary of the previous picture in the encoding sequence) of the intra slice for the present picture and the coordinate of the lower end of the intra slice (refresh boundary of the present picture). In addition, the intra slice width setting unit 13 saves the coordinate of the lower end of the intra slice to the memory included in the intra slice width setting unit 13.

The encoding unit 14 set a reference range whether the refreshed region or not based on the width and the position of the intra slice set by the intra slice width setting unit 13, for the picture to be encoded. The encoding unit 14 encodes each block in the picture to be encoded according to the limitation. For example, the encoding unit 14 limits the reference range of each block within the refreshed region of the picture to be encoded to the refreshed region of the encoded picture whose encoding sequential order is before that of the picture or the encoded pixel within the refreshed region of the picture. Furthermore, in each block included in the intra slice of the picture to be encoded, the encoding unit 14 may limit the reference range to the encoded pixel within the refreshed region of the picture. On the other hand, in each block included in an unrefreshed region of the picture to be encoded, the encoding unit 14 may set the reference range regardless of the refreshed region and the unrefreshed region.

In the present embodiment, the apparatus for encoding a moving picture 1 encodes each picture according to HEVC. Therefore, the picture to be encoded is divided into a coding tree unit (CTU) and each CTU is encoded in raster scan order. The structure of the CTU will be described.

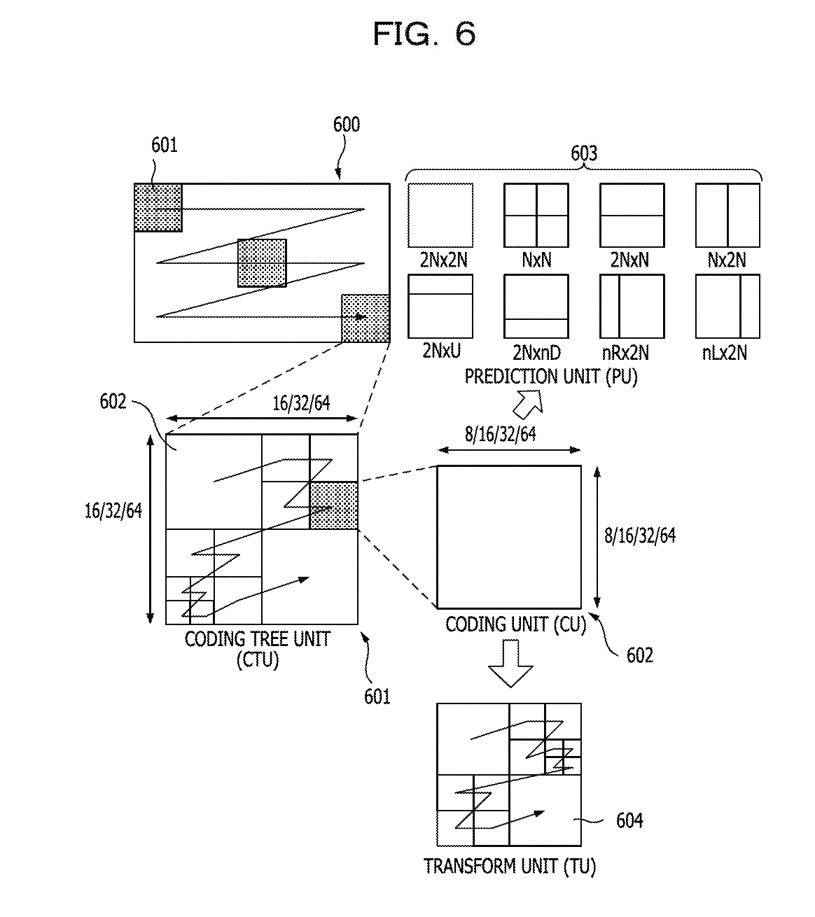

FIG. 6 is a diagram illustrating an example of a divided structure of the picture by the HEVC. As illustrated in FIG. 6, a picture 600 is divided into a CTU. The size of a CTU 601 can be selected from the 64×64 to 16×16 pixels. However, the size of the CTU 601 is uniform in a sequence unit.

The CTU 601 further is divided into a plurality of coding units (CU) 602 into a quad-tree structure. Each CU 602 in one CTU 601 is encoded in Z scan order. The size of the CU 602 is variable and the size thereof is selected from CU dividing modes 8×8 to 64×64 pixels. The CU 602 is a unit for selecting the encoding mode to be applied from an intra prediction encoding mode and an inter prediction encoding mode. The CU 602 is individually processed in a prediction unit (PU) 603 or in a transform unit (TU) 604. The PU 603 is a unit in which prediction in accordance with the encoding mode is performed. For example, in the intra prediction encoding mode, the PU 603 is a unit in which prediction mode for defining a calculation method of a value of each pixel of the prediction block and the pixel to be referred when the prediction block is generated is applied. On the other hand, in the inter prediction encoding mode, the PU 603 is a unit for performing motion compensation. In the inter prediction encoding, the size of the PU 603 is selected, for example, from PU dividing modes PartMode=2N×2N, N×N, 2N×N, N×2N, 2N×U, 2N×nD, nR×2N, and nL×2N. On the other hand, the TU 604 is the unit for the orthogonal transform. The size of the TU 604 is selected from 4×4 pixels to 32×32 pixels. The TU 604 is divided into the quad-tree structure and is processed in the Z scan order.

The encoding unit 14 executes an encoding process for each CTU. Hereinafter, a process of the encoding unit 14 with respect to one CTU will be described.

For each PU which is applicable in the CTU, the motion estimation unit 21 executes block matching between the PU and the reference region of a local decoding picture which is obtained by decoding the encoded picture once by the apparatus for encoding a moving picture 1. The motion estimation unit 21, for each of the PUs, can obtain a motion vector by determining the local decoding picture which is most corresponding to the PU and a position on the local decoding picture.

In this time, regarding the PU included in the refreshed region, the motion estimation unit 21 set the reference region within the refreshed region on the local decoding picture. On the other hand, regarding the PU included in the unrefreshed region, the motion estimation unit 21 may set the reference region in not only the refreshed region of the local decoding picture but also the unrefreshed region.

In addition, for the PU included in the intra slice, in a case where the encoding mode to be applied is limited to the intra prediction encoding mode, the motion estimation unit 21 may not calculate the motion vector regarding the PU.

The motion estimation unit 21 saves the motion vector each PU in the storage unit 28 and outputs the motion vector to the encoding mode determination unit 22.

The encoding mode determination unit 22 determines the dividing modes of the CU, the PU, and the TU for dividing the encoding target CTU, and the encoding mode to be applied for each CU.

The encoding mode determination unit 22 calculates each encoding cost, that is an evaluation value of the encoded data amount of the encoding target CTU for the applicable encoding mode, in the CU. For example, regarding the inter prediction encoding mode, the encoding mode determination unit 22 calculates the encoding cost for each combination of the CU dividing mode and PU dividing mode which divide the CTU and a vector mode for defining a generating method of the prediction vector of the motion vector. The encoding mode determination unit 22 can use any of an adaptive motion vector prediction (AMVP) mode and a merge mode as the vector mode, for example. However, the encoding mode determination unit 22 does not use the motion vector of the encoded PU included in the unrefreshed region, as a prediction vector of the motion vector of the PU included in the refreshed region. On the other hand, the encoding mode determination unit 22 may be use the motion vector of the encoded PU included in the unrefreshed region, as the prediction vector of the motion vector of the PU included in the unrefreshed region.

In addition, regarding the intra prediction encoding mode, the encoding mode determination unit 22 calculates the encoding cost for each combination of the CU dividing mode and the PU dividing mode which divides the CTU and the prediction mode. Regarding the PU included in the refreshed region, the encoding mode determination unit 22 prohibits the application of the prediction mode referring to the pixel in the unrefreshed region. On the other hand, regarding the PU included in the unrefreshed region, the encoding mode determination unit 22 may apply the prediction mode referring to the pixel in the unrefreshed region.

For calculating the encoding cost, the encoding mode determination unit 22 calculates, for example, a prediction error, that is a sum of absolute pixel differences SAD, for the focusing PU, according to the following expression.

SAD=Σ|OrgPixel−PredPixel|

Here, OrgPixel represents a value of the pixel included in the focusing PU and PredPixel represents a value of the pixel included in the prediction block corresponding to the focusing block. The prediction block is a prediction block generated according to the encoding mode that is a calculation target of the encoding cost.

The encoding mode determination unit 22 calculates, for example, an encoding cost Cost for the focusing CU according to the following expression.

Cost=ΣSAD+λ*B

Here, ΣSAD represents a total sum of the calculated SADs for each PU included in the focusing CU. In addition, B represents an estimation value of the encoding amount for an item such as a flag indicating the motion vector and the prediction mode other than the prediction error. The λ represents the Lagrange's undetermined multiplier.

The encoding mode determination unit 22 may calculate a sum of the absolute values SATD of each pixel after the difference image between the focusing PU and the prediction block is subjected to the Hadamard transformation, or the like, instead of the SAD.

The encoding mode determination unit 22 sets, for example, the focusing CU in decreasing order of the size among the obtaining CU sizes, for the CTU to be encoded. The encoding mode determination unit 22 selects the prediction mode in which the cost is minimized for each PU dividing mode in the CU relating to the intra prediction encoding mode, for the focusing CU. In addition, the encoding mode determination unit 22 selects the vector mode in which the cost is minimized for each PU dividing mode in the CU relating to the inter prediction encoding mode, for the focusing CU. Furthermore, the encoding mode determination unit 22 selects a mode in which the encoding cost is small among the intra prediction encoding mode and the inter prediction encoding mode, for each CU having the same size, as an encoding mode to be applied in the CU. Regarding the CU included in the intra slice, the encoding mode determination unit 22 may select the intra prediction encoding mode as an applying encoding mode without calculating the encoding cost for the inter prediction encoding mode.

Furthermore, the encoding mode determination unit 22 executes the same process for each of the CUs which is obtained by dividing the focusing CU into four CUs as a next focusing CU, and calculates a minimum encoding cost. If the total sum of the minimum encoding costs which are calculated for each of the four divided CUs is smaller than the minimum encoding cost for the focusing CU, the encoding mode determination unit 22 divides the focusing CU into four. The encoding mode determination unit 22 determines the CU dividing mode and the PU dividing mode to be applied to the CTU to be encoded by repeating the above processes until each CU is not divided.

The encoding mode determination unit 22 set the CU dividing mode such that the CU is not set over the refresh boundary. For example, in above-described determination process of the encoding mode, the encoding mode determination unit 22 may set the encoding cost for the CU over the refresh boundary to a very large value as the CU is not selected. Alternatively, the encoding mode determination unit 22 may not select the CU dividing mode including the CU in which the encoding cost is not calculated, without calculating the encoding cost for the CU over the refresh boundary.

Furthermore, the encoding mode determination unit 22 determines the TU dividing mode for each CU according to the CU dividing mode which is determined in the above-described manner. In this case, the encoding mode determination unit 22 calculates a RD cost Cost according to the following expression, for each applicable TU dividing mode.

$$Cost = {\sum }_{i} {( org ( i ) - Idec ( i ) )}^{2} + λ \cdot bit \qquad ( 1 )$$

Here, org(i) represents a value of the pixel included in the focusing CU and Idec(i) represents a value of a decoding pixel obtained such that the CU is encoded by using the TU dividing mode and further decoded. In addition, bit represents an encoding amount when the CU is encoded by using the focusing TU dividing mode. A first item of the right side in the (1) Expression represents an encoding distortion and a second item of the right side represents the encoding amount. Therefore, in the TU dividing mode in which the RD cost becomes minimized, an optimum balance between the encoding distortion and the encoding amount is obtained.

The encoding mode determination unit 22 selects the TU dividing mode in which the RD cost Cost becomes minimized.

The encoding mode determination unit 22 notifies the prediction block generation unit 23 of the combination of the CU and PU dividing modes which are selected for CTU to be encoded and the encoding mode. In addition, the encoding mode determination unit 22 saves the combination of the CU, PU, and TU dividing modes which are selected for the CTU to be encoded and the encoding mode to the storage unit 28.

The prediction block generation unit 23 generates the prediction block for each PU according to the combination of the sizes of the CU, PU, and TU which are selected for the CTU to be encoded and the encoding mode. For example, in a case where the focusing CU is subjected to the intra prediction encoding, the prediction block generation unit 23 generates the prediction block by motion compensating the local decoding picture which is read form the storage unit 28 for each PU in the CU based on the motion vector calculated for the PU.

In addition, in a case where the focusing CU is subjected to the intra prediction encoding, the prediction block generation unit 23 generates the prediction block to be referred according to the prediction mode which is selected for each PU in the CU, based on the value of the pixel in the local decoding block around the PU.

The prediction block generation unit 23 transmits the generated prediction block to the prediction error calculation unit 24 and the decoding unit 27.

The prediction error calculation unit 24 executes a difference operation between the corresponding pixels of the prediction block generated by the prediction block generation unit 23, for each pixel in the CTU to be encoded. The prediction error calculation unit 24 sets the difference value corresponding to each pixel in the TU obtained by the difference operation as a prediction error signal of the TU, for each TU. The prediction error calculation unit 24 transmits the prediction error signal for each TU to the orthogonal transformation unit 25.

The orthogonal transformation unit 25 obtains a frequency component of the prediction error signal in a horizontal direction and an orthogonal transform coefficient indicating the frequency component in the vertical direction by orthogonal transforming the prediction error signal of the TU, for each TU in the CTU to be encoded. For example, the orthogonal transformation unit 25 executes the discrete cosine transform (DCT) as a orthogonal transform process with respect to the prediction error signal to obtain a set of the DCT coefficients as the orthogonal transform coefficient.

The orthogonal transformation unit 25 transmits the orthogonal transform coefficient for each TU to the quantization unit 26.

The quantization unit 26 quantizes the orthogonal transform coefficient for each TU according to a quantization parameter including such as a qp value which designates a quantization width to calculate the quantized orthogonal transform coefficient. Hereinafter, the quantized orthogonal transform coefficient is simply referred to as a quantization coefficient in some cases.

The quantization unit 26 outputs the decoding unit 27 of the quantization coefficient to the entropy encoding unit 29.

The decoding unit 27 generates a local decoding block which is referred for encoding the CU or the like after than the TU from the quantization coefficient each TU in the CTU to be encoded, and stores the local decoding block to the storage unit 28.

Accordingly, the decoding unit 27 performs inverse transformation of the quantization coefficient of each TU to reconstruct the orthogonal transform coefficient before being quantized.

The decoding unit 27 performs the inverse orthogonal transformation with respect to the reconstructed orthogonal transform coefficient, for each TU. For example, in a case where the orthogonal transformation unit 25 uses a DCT as the orthogonal transformation, the decoding unit 27 executes an inverse DCT process as the inverse orthogonal transformation. Accordingly, the decoding unit 27 reconstructs the prediction error signal having information being same as that of the prediction error signal before being quantized, for each TU.

The decoding unit 27 adds the reconstructed prediction error signal to each pixel value of the prediction block of the TU, for each TU to generate the local decoding block.

The decoding unit 27 saves the local decoding block to the storage unit 28 every time when the local decoding block is generated.

In addition, the decoding unit 27 may execute deblocking filtering or in-loop filtering that is a sample adaptive offset process with respect to the local decoding block stored in the storage unit 28. However, the decoding unit 27 does not execute the in-loop filtering over the refresh region.

The storage unit 28 temporarily stores the local decoding block which is received from the decoding unit 27. The local decoding picture is obtained by a combination of the local decoding block for one picture according to the encoding sequence of the each CTU. The storage unit 28 supplies the local decoding picture or the local decoding block to the motion estimation unit 21, the encoding mode determination unit 22, and the prediction block generation unit 23. The storage unit 28 stores the given number of the local decoding pictures set in advance, that is a possibility that the local decoding picture is to be referred by the encoding target picture. In a case where the number of the local decoding picture exceeds the given number, the storage unit 28 discards the oldest local decoding picture in the encoding sequence.

In addition, the storage unit 28 stores the motion vector for each of the local decoding block which is subjected to the inter prediction encoding. Furthermore, the storage unit 28 stores a combination of the CU, PU, and TU dividing modes which are selected for each CTU and the encoding mode.

The entropy encoding unit 29 performs entropy encoding of syntax for specifying the prediction vector, the quantization coefficient of each TU of the CTU to be encoded, and a prediction error signal of the motion vector of each PU. In the present embodiment, the entropy encoding unit 29 uses an arithmetic encoding process that is a context-based adaptive binary arithmetic coding (CABAC) as an entropy encoding technique. The entropy encoding unit 29 combines bit streams obtained through the entropy encoding in a given sequence, and adds header information or the like defined by HEVC to obtain the encoded bit stream including the encoded moving picture data. The entropy encoding unit 29 outputs the encoded bit stream.

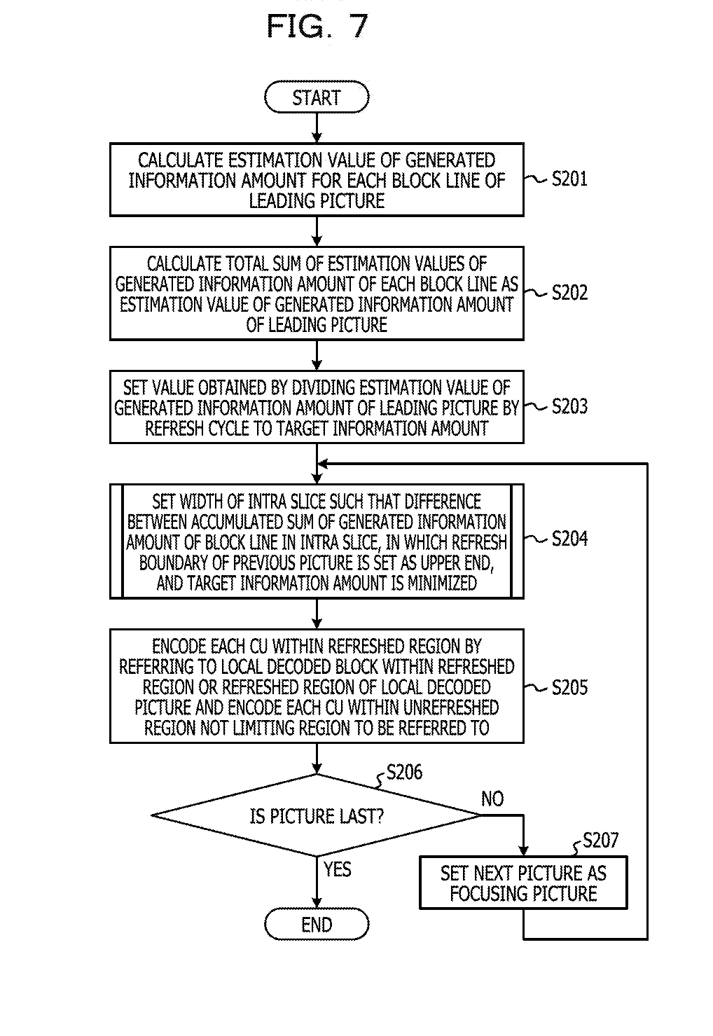

FIG. 7 is a flowchart of operation of a moving picture encoding process according by the apparatus for encoding a moving picture 1. The apparatus for encoding a moving picture 1 encodes each picture within the refresh cycle according to the flowing operation flowchart for each refresh cycle.

The generated information amount estimation unit 11 calculates the estimation value of the generated information amount for each block line of the leading picture of the refresh cycle (step S201). The generated information amount estimation unit 11 calculates the total sum of the estimation values of the generated information amount of each block line as the estimation value of the generated information amount of the leading picture (step S202). The generated information amount estimation unit 11 notifies the target information amount setting unit 12 of the estimation value of the generated information amount of the leading picture. In addition, the generated information amount estimation unit 11 notifies the intra slice width setting unit 13 of the estimation value of the generated information amount for each block line.

The target information amount setting unit 12 set the value obtained by dividing the estimation value of the generated information amount of the leading picture by the refresh cycle as the target information amount (step S203). The target information amount setting unit 12 notifies the intra slice width setting unit 13 of the target information amount.

The intra slice width setting unit 13 set the width of the intra slice such that the difference between the total sum of the generated information amounts of the block line from the refresh boundary of the previous picture and the target information amount becomes minimized, for the focusing picture within the refresh cycle (step S204). The refresh boundary of the previous picture becomes an upper end of the intra slice in the focusing picture. In this case, the intra slice width setting unit 13 uses the estimation value of the generated information amount of each block line of the leading picture as the estimation value of the generated information amount of the block line at a position same as that of the focusing picture. The intra slice width setting unit 13 notifies the encoding unit 14 of the width of the intra slice and the position of the intra slice for each picture within the refresh cycle.

The encoding unit 14 encodes each CU within the refreshed region by referring to the refreshed region of the local decoding picture or the local decoding block within the refreshed region, for the focusing picture (step S205). Furthermore, the encoding unit 14 encodes each CU within the unrefreshed region without limitation of the region to be referred.

A control unit (not illustrated) of the apparatus for encoding a moving picture 1 determines whether the focusing picture is the last picture in the encoding sequence, within the refresh cycle (step S206). If the focusing picture is not the last picture in the encoding sequence within the refresh cycle (step S206—No), the control unit set the next picture of the focusing picture in the encoding sequence to the next focusing picture (step S207). The apparatus for encoding a moving picture 1 repeats processing of step S204 onward.

On the other hand, in a case where the focusing picture is the last picture in the encoding sequence within the refresh cycle (step S206—Yes), the apparatus for encoding a moving picture 1 terminates the moving picture encoding process.

As described above, in the apparatus for encoding a moving picture, the intra-refresh technique is applied. The apparatus for encoding a moving picture sets the width of the intra slice of each picture such that the generated information amounts of the intra slice are equalized, for each picture within the refresh cycle. Therefore, even in the picture including still subject having a complicated pattern locally, not only the picture with large movement, the apparatus for encoding a moving picture constantly maintains the refresh cycle and can suppress the variation in the generated information amount of the intra slice between the pictures. Accordingly, the apparatus for encoding a moving picture can suppress the variation in the encoding amount of each picture within the refresh cycle. As a result, the apparatus for encoding a moving picture can suppress the deterioration in the image quality of the moving picture data. Furthermore, since the apparatus for encoding a moving picture maintain the refresh cycle constantly, in a case where the encoded moving picture data is decoded in the middle, it is possible to suppress the period until the picture can be displayed from being increased.

Next, the apparatus for encoding a moving picture according to a second embodiment will be described. The apparatus for encoding a moving picture according to the second embodiment obtains the estimation value of the generated information amount of the region corresponding to the unrefreshed region in the previous picture in the encoding sequence, for each picture within the refresh cycle. The apparatus for encoding a moving picture sets the intra slice width by dividing the estimation value by a remaining period of the refresh cycle.

In the apparatus for encoding a moving picture according to the second embodiment, the processes of the generated information amount estimation unit 11 and the target information amount setting unit 12 are different relative to the apparatus for encoding a moving picture according to the first embodiment. Hereinafter, the generated information amount estimation unit 11, the target information amount setting unit 12, and the relation portion will be described.

The generated information amount estimation unit 11 calculates the estimation value of the generated information amount of the region corresponding to the unrefreshed region in the previous picture in the encoding sequence, for each picture within the refresh cycle. However, the estimation value of the generated information amount of the overall leading picture is calculated, for the leading picture.

Therefore, for the unrefreshed region of the previous picture in the encoding sequence, the generated information amount estimation unit 11 calculates, for example, the total sum of the SADs of each CU included in the block line for each block line having a given width as the estimation value of the generated information amount of the block line. The SAD of each CU included in the block line can be set as the sum of the SADs of each PU included in the CU corresponding to the minimum value of the encoding cost in the intra prediction encoding mode of the CU, which is calculated by the encoding mode determination unit 22, for example. The SAD of each CU is an example of the evaluation value of the encoding amount. The SAD of each CU is saved in a buffer (not illustrated) by the encoding mode determination unit 22, for example, so as to being used by the generated information amount estimation unit 11. For example, in a case where the given width is 8 pixels, for each CU having a size of 8×8 pixels included in the block line, the SAD corresponding to the minimum value of the encoding cost in a case where the intra prediction encoding mode is to be applied is used for calculating the estimation value of the generated information amount of the block line thereof. Since the SAD is calculated by the encoding mode determination unit 22 in advance, the generated information amount estimation unit 11 can reduce the operating amount desired for calculating of the estimation value of the generated information amount for each block line. In addition, by using the SAD for previous picture which has high correlation between the focusing pictures for calculating the generated information amount, the generated information amount estimation unit 11 can improves the estimation accuracy of the generated information amount for each block line.

Even in the present embodiment, the generated information amount estimation unit 11 may use the SATD instead of the SAD.

The generated information amount estimation unit 11 calculates the total sum of the estimation values of the generated information amount of each block line included in the unrefreshed region of the previous picture as the estimation value of the generated information amount for a region of the focusing picture corresponding to the unrefreshed region.

According to an modification example, the generated information amount estimation unit 11 calculate a distribution of luminance brightness value for each block line included in a region of the focusing region corresponding to the unrefreshed region of the previous picture in the encoding sequence, and may calculate the distribution as the estimation value of the generated information amount of the block line.

The generated information amount estimation unit 11 notifies the target information amount setting unit 12 of the estimation value of the generated information amount of the region of the focusing picture corresponding to the unrefreshed region of the previous picture. The generated information amount estimation unit 11 notifies the intra slice width setting unit 13 of the estimation value of the generated information amount for each block line within the unrefreshed region of the previous picture.

The target information amount setting unit 12 sets the target information amount of the generated information amount of the intra slice in the focusing picture based on the estimation value of the generated information amount of the region of the focusing picture corresponding to the unrefreshed region of the previous picture in the encoding sequence and the remaining period of the refresh cycle.

In the present embodiment, the target information amount setting unit 12 sets the value obtained by dividing the estimation value of the generated information amount of the region of the focusing picture corresponding to the unrefreshed region of previous picture in the encoding sequence by the number of the pictures included in the remaining period of the refresh cycle as the target information amount. However, regarding the picture that is last in the encoding sequence within the refresh cycle, since the lower end of the picture becomes the fresh boundary, the process of the target information amount setting unit 12 may be omitted.

The target information amount setting unit 12 notifies the intra slice width setting unit 13 of the target information amount.

The intra slice width setting unit 13 sets the width of the intra slice such that the difference between the estimation value of the generated information amount of the intra slice of the picture and the target information amount is minimized, for each picture within the refresh cycle. The intra slice width setting unit 13 may set the width of the intra slice according to the operation flowchart of the intra slice width setting process illustrated in FIG. 4.

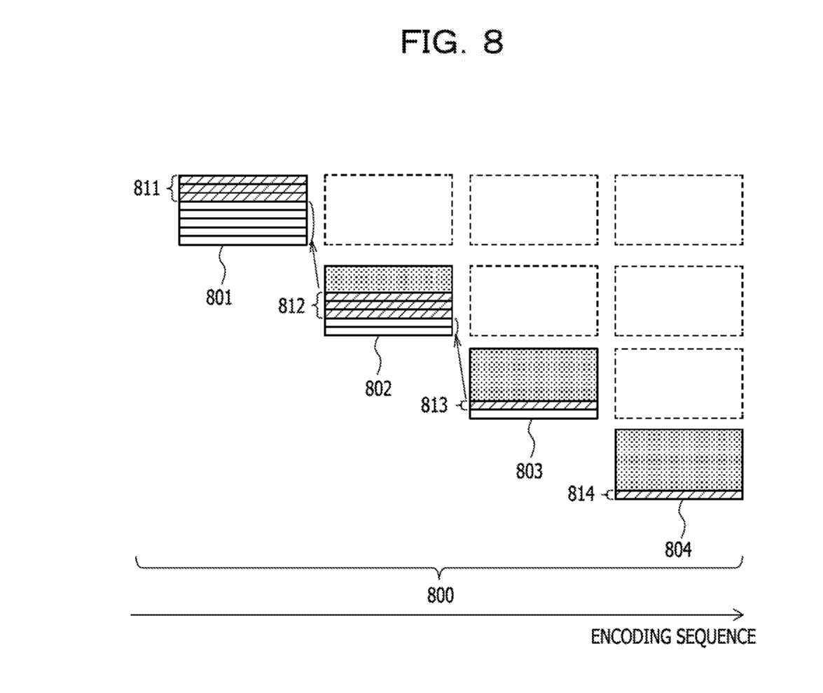

FIG. 8 is a diagram illustrating an example of the intra slice set in each picture within one refresh cycle according to the present embodiment. In FIG. 8, the horizontal axis represents the encoding sequence. In this example, four pictures 801 to 804 are included within a refresh cycle 800 in the encoding sequence. For example, the refresh cycle is four. Each of intra slices 811 to 814 is set in each picture. In this example, the target information amount of the intra slice 811 set in the picture 801 is set as a value obtained by dividing the estimation value of the generated information amount of the overall picture 801 by four that is the refresh cycle. The width of the intra slice 811 is set such that the estimation value of the generated information amount of the overall intra slice 811 is closest to the target information amount.

As the same manner, the target information amount of the intra slice 812 set in the picture 802 is set as a value obtained by dividing the estimation value of the generated information amount of the region of the picture 802 corresponding to the unrefreshed region of the picture 801 (e.g. a region lower than the intra slice 811) by three. The width of the intra slice 812 is set such that the estimation value of the generated information amount of the overall intra slice 812 is closest to the target information amount. In addition, the target information amount of the intra slice 813 set in the picture 803 is set as a value obtained by dividing the estimation value of the generated information amount of the region of the picture 803 corresponding to the unrefreshed region of the picture 802 (e.g. a region lower than the intra slice 812) by two. The width of the intra slice 813 is set such that the estimation value of the generated information amount of the overall intra slice 813 is closest to the target information amount. Finally, the intra slice 814 of the picture 804 is set so as to include the entire region lower than the intra slice 813.

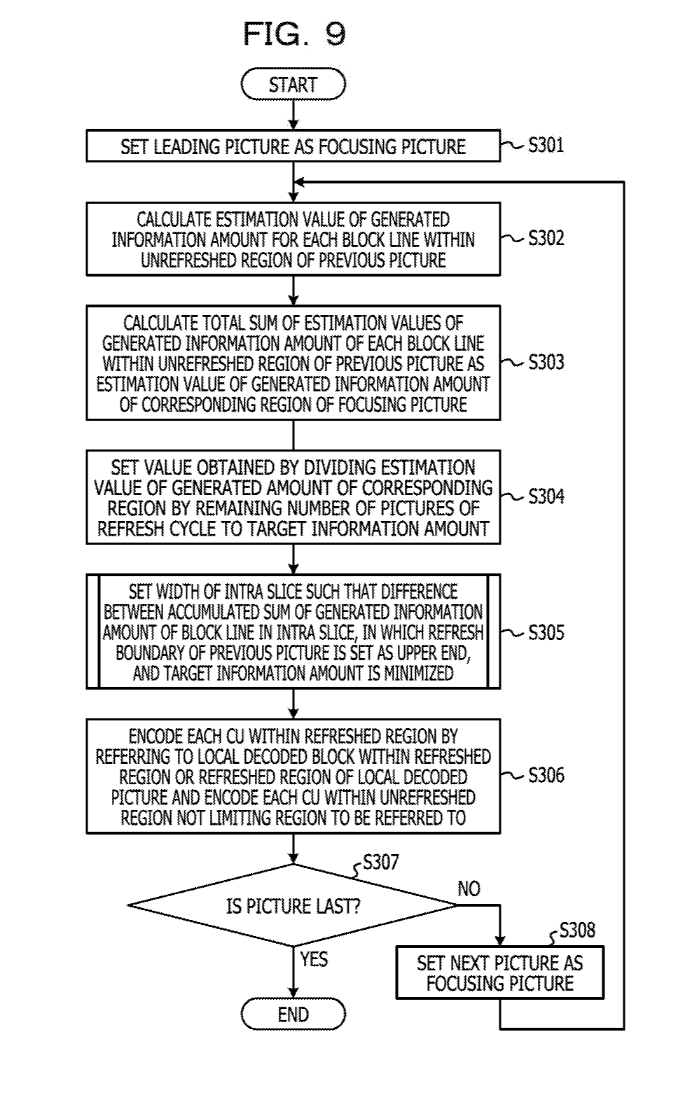

FIG. 9 is a flowchart of operation of a moving picture encoding process according to the embodiment.

The apparatus for encoding a moving picture 1 encodes each picture within the refresh cycle according to the flowing operation flowchart for each refresh cycle.

The control unit (not illustrated) of the apparatus for encoding a moving picture 1 set the leading picture of the refresh cycle as the focusing picture (step S301). The generated information amount estimation unit 11 calculates the estimation value of the generated information amount for each block line included in the unrefreshed region of the previous picture in the encoding sequence (step S302). The generated information amount estimation unit 11 calculates the total sum of the estimation value of the generated information amount of each block line included in the unrefreshed region as the estimation value of the generated information amount of the region of the focusing picture corresponding to the unrefreshed region (step S303). The generated information amount estimation unit 11 notifies the target information amount setting unit 12 of the estimation value of the generated information amount of the corresponding region. The generated information amount estimation unit 11 notifies the intra slice width setting unit 13 of the estimation value of the generated information amount for each block line within the unrefreshed region.

The target information amount setting unit 12 set the value obtained by dividing the estimation value of the generated information amount of the corresponding region by the number of pictures included in the remaining period within the refresh cycle, as the target information amount (step S304). The target information amount setting unit 12 notifies the intra slice width setting unit 13 of the target information amount.

The intra slice width setting unit 13 set the width of the intra slice such that the difference between the total sum of the generated information amounts of the block line from the upper end of the intra slice that is the refresh boundary of the previous picture in the encoding sequence and the target information amount becomes minimized (step S305). The intra slice width setting unit 13 notifies the encoding unit 14 of the width of the intra slice and the position of the intra slice for each picture within the refresh cycle.

The encoding unit 14 encodes each CU within the refreshed region by referring to the refreshed region of the local decoding picture or the local decoding block within the refreshed region, for the focusing picture (step S306). Furthermore, the encoding unit 14 encodes each CU within the unrefreshed region without limitation of the region to be referred.

The control unit (not illustrated) determines whether the focusing picture is the last picture in the encoding sequence within the refresh cycle (step S307). If the focusing picture is not the last picture in the encoding sequence within the refresh cycle (step S307—No), the control unit set the next picture of the focusing picture in the encoding sequence to the next focusing picture (step S308). The apparatus for encoding a moving picture 1 repeats processing of step S302 onward.

On the other hand, in a case where the focusing picture is the last picture in the encoding sequence within the refresh cycle (step S307—Yes), the apparatus for encoding a moving picture 1 terminates the moving picture encoding process.

As described above, the apparatus for encoding a moving picture according to the second embodiment set the target information amount of the generated information amount of the intra slice based on the generated information amount of the region corresponding to the unrefreshed region of the previous picture in the encoding sequence, for each picture. Therefore, since the generated information amount of the intra slice of each picture can be more accurately estimated, the apparatus for encoding a moving picture can set the width of the intra slice more appropriately.

According to the modification example of each of the above-described embodiments, the generated information amount estimation unit 11 may use the generated information amount of the corresponding block line included in the intra slice of the any pictures included in the previous refresh cycle, as the estimation value of the generated information amount for each block line. In this case, for example, the generated information amount can be set as the encoding amount of the encoding data which is obtained by encoding each CU included actually in the block line. The encoding amount is the other example of the evaluation value of the encoding amount. The encoding amount of each CU is saved in a buffer (not illustrated) by the entropy encoding unit 29, for example, so as to being used by the generated information amount estimation unit 11.

Also in this case, the generated information amount estimation unit 11 can set the total sum of the estimation values of the generated information amount of each block line of overall picture as the estimation value of the generated information amount of the overall picture. Alternatively, the generated information amount estimation unit 11 can set the total sum of the estimation value of the generated information amount of each block line of the region of the focusing picture corresponding to the unrefreshed region of the previous region in the encoding sequence, as the estimation value of the generated information amount of the corresponding region.

Also in this modification example, the target information amount setting unit 12 and the intra slice width setting unit 13 may be set the width of the position of the intra slice of each picture and the target information amount in the same manner as the first embodiment or the second embodiment.

Alternatively, in this modification example, in a case where the target information amount setting unit 12 set the target information amount in the same manner as the first embodiment, the intra slice width setting unit 13 may set the width of the intra slice of each picture according to the flowing expression.

IntraSliceSize=(X/IntraBitNLine)·N

N=PicSize/RefreshCycle (2)

Here, X represents the target information amount and PicSize represents the number of pixels of the picture in the refresh direction (in this example, a vertical direction). In addition, RefreshCycle represents the refresh cycle. IntraBitNLine represents a total sum of the estimation values of the generated information amount of each block line included in a region of N pixel width from the upper end of the intra slice for each focusing pixel. The IntraSliceSize represents the width of the intra slice.

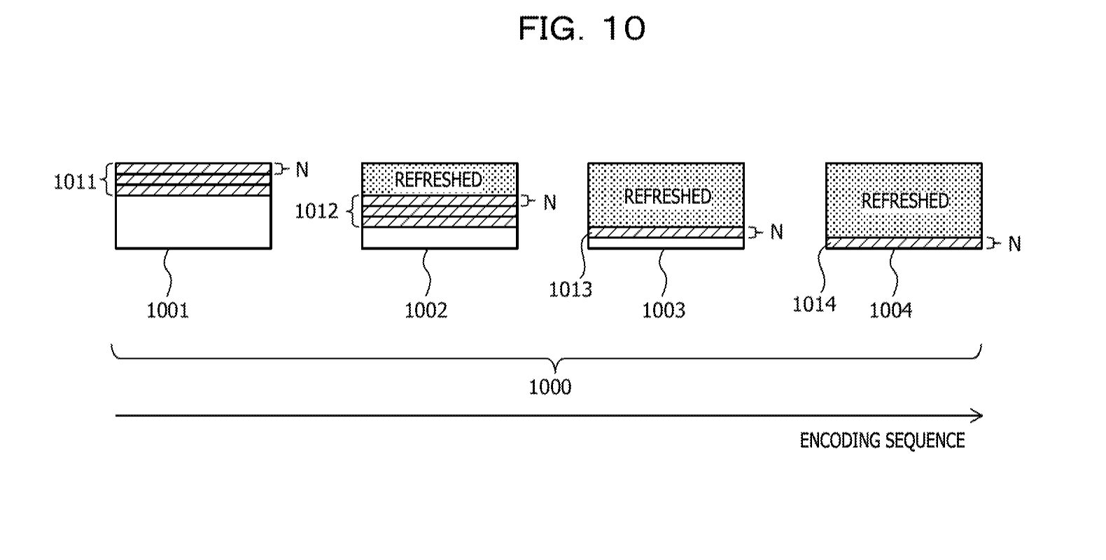

FIG. 10 is a diagram illustrating an example of an intra slice which is set in each picture within one refresh cycle according to the modification example. In FIG. 10, the horizontal axis represents an encoding sequence. In this example, four pictures 1001 to 1004 are included in a refresh cycle 1000 in the encoding sequence. Each of intra slices 1011 to 1014 is set in each picture. In this example, since the value of the IntraNBitLine is smaller than the target information amount of the intra slice 1011 to be set in the picture 1001 and the target information amount of the intra slice 1012 to be set in the picture 1002, the width of the intra slice 1012 is set so as to greater than the N pixel. In addition, since the target information amounts of the intra slices 1013 and 1014 to be set in pictures 1003 and 1004 are identical to the value of the IntraBitNLine, the widths of the intra slices 1013 and 1014 is set to N pixel.

In addition, the target information amount setting unit 12 may set a encoding amount of the intra slice of the picture in which the position is identical to the position within the previous refresh cycle, as the target information amount of the intra slice of the picture, for each picture with in the refresh cycle. For example, in a case where the focusing picture is an m-th picture from the leading of the refresh cycle, the sum of the decoding amounts of each CU included in the intra slice of the m-th picture is set as the target information amount of the focusing picture. In this case, the intra slice width setting unit 13 may set the intra slice width for each picture within the refresh cycle according to the flowing expression.

IntraSliceSize=(X/intraBitMLine)·M (3)

Here, X represents the target information amount for the focusing picture. M represents a width of the intra slice of the picture at the same position as that of the focusing picture in the previous refresh cycle. IntraBitMLine represents a total sum of the estimation values of the generated information amount of the each block line included in a region of M pixel width from the upper end of the intra slice in the focusing picture. IntraSliceSize represents the width of the intra slice.

According to these modification examples, since the estimation value of the generated information amount can be obtained based on the encoding amount of the picture encoded in advance, the apparatus for encoding a moving picture can reduce the operation amount desired for calculating of the estimation value of the generated information amount. In addition, in a case of the subject in each picture with less movement or in a case where the refresh cycle is short, correlation between each picture of the present refresh cycle and each picture of the previous refresh cycle is high. Therefore, according to theses modification examples, the apparatus for encoding a moving picture can estimate the generated information amount of the intra slice accurately.

Next, the apparatus for encoding a moving picture according to the third embodiment will be described. The apparatus for encoding a moving picture according to the third embodiment hierarchically encodes the moving picture data spatially. The apparatus for encoding a moving picture calculates the estimation value of the generated information amount of the leading picture using the SAD or the encoding amount which is calculated when determining the encoding mode of the reducing picture which is generated by thinning out the leading picture of the refresh cycle included in the moving picture data.

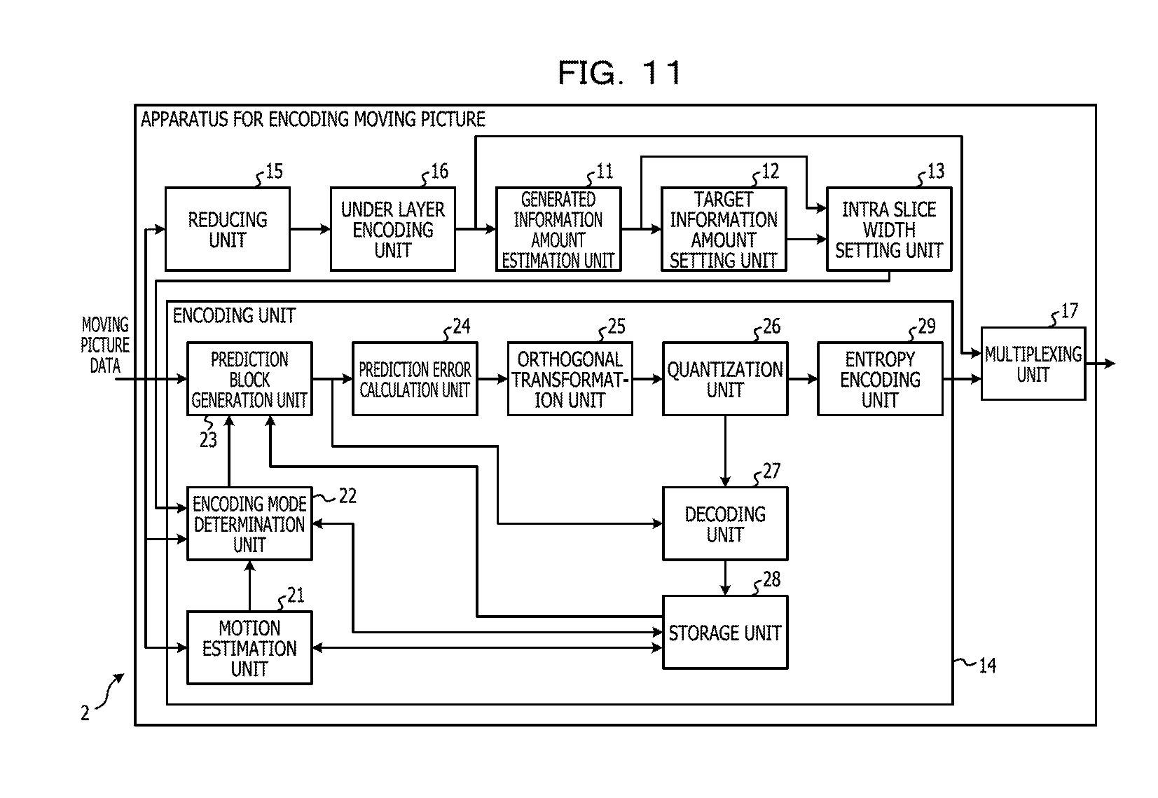

FIG. 11 is a schematic configuration diagram of the apparatus for encoding a moving picture according to the third embodiment. As illustrated in FIG. 11, an apparatus for encoding a moving picture 2 according to the third embodiment includes a reducing unit 15, a under layer encoding unit 16, the generated information amount estimation unit 11, the target information amount setting unit 12, the intra slice width setting unit 13, the encoding unit 14, and a multiplexing unit 17. The encoding unit 14 includes the motion estimation unit 21, the encoding mode determination unit 22, the prediction block generation unit 23, the prediction error calculation unit 24, the orthogonal transformation unit 25, the quantization unit 26, the decoding unit 27, the storage unit 28, and the entropy encoding unit 29.

Each unit included in the apparatus for encoding a moving picture 2 is formed as a separate circuit, respectively. Alternatively, these units included in the apparatus for encoding a moving picture 2 may be mounted at the apparatus for encoding a moving picture 2 as a single or a plurality of integrated circuits in which a circuit corresponding to each unit is integrated. Furthermore, each unit included in the apparatus for encoding a moving picture 2 may be a functional module which is realized by a computer program which is executed on a processor included in the apparatus for encoding a moving picture 2. For example, by executing a computer program stored in a memory included in the apparatus for encoding a moving picture 2 on the processor, the processor included in the apparatus for encoding a moving picture 2 can be operated as a hardware circuit which can execute a part or overall process of each unit illustrated in FIG. 11.

In the apparatus for encoding a moving picture 2 according to the third embodiment, the processes of the generated information amount estimation unit 11 is different relative to the apparatus for encoding a moving picture 1 according to the first embodiment, in that the apparatus for encoding a moving picture includes the reducing unit 15, the under layer encoding unit 16, and the multiplexing unit 17. Hereinafter, the reducing unit 15, the under layer encoding unit 16, the multiplexing unit 17, and the generated information amount estimation unit 11, and the relation portion will be described.

In the reducing unit 15, each picture included in the moving picture data to be encoded is sequentially input according to the encoding sequence. The reducing unit 15 performs down sampling of the input picture to generate reduced picture having the pixel number less than the pixel number of the picture. As compared to an original picture (e.g. higher hierarchy picture), the reduced picture is a lower hierarchy picture in which the resolution is relatively low. For example, the reducing unit 15 generates a reduced picture having a size in which the input picture is n pixel in a horizontal direction and m pixel in a vertical direction and in a case where the reducing rate in the horizontal direction is d1 and the reduction rate in the vertical direction is d2, the input picture has a n*d1 pixel in the horizontal direction and a m*d2 pixel in the vertical direction. The reducing rates d1 and d2 are positive values equal to or lower than 1, for example, ½.

The reducing unit 15, for example, applies a Gaussian filter or a smoothing filter such as an averaging filter to each pixel of the input picture to smoothen the picture. The reducing unit 15 generates the reduced picture by sub-sampling the smoothened picture according to the reducing rates in the horizontal direction and the vertical direction.

The reducing unit 15 outputs the reduced picture to the under layer encoding unit 16 every time when the reduced picture is generated.

The under layer encoding unit 16 encodes the reduced picture. In this time, the under layer encoding unit 16 applies, for example, the encoding process as that of the encoding process by the encoding unit 14 to the reduced picture to encode the reduced picture. However, the under layer encoding unit 16 may set the encoding mode to be applied in each reduced picture according to group of pictures (GOP). Alternatively, the under layer encoding unit 16 is set the encoding mode to be applied in each reduced picture as the intra prediction encoding mode.

The under layer encoding unit 16 outputs the bit stream including the encoding data of each reduced picture to the multiplexing unit 17. In addition, the under layer encoding unit 16 outputs the SAD corresponding to the minimum encoding cost which is calculated for each CU of each reduced picture to the generated information amount estimation unit 11.

In the same manner as that of the first embodiment, the generated information amount estimation unit 11 calculates the estimation value of the generated information amount for each block line having a given width along the refresh direction, for the leading picture within the refresh cycle. The generated information amount estimation unit 11 calculates the total sum of the estimation values of the generated information amount of each block line as the estimation value of the generated information amount of the overall leading picture.

However, in the present embodiment, the generated information amount estimation unit 11 calculates the total sum of the encoding amount or the SADs of the CU of the reduced picture corresponding to each CU included in the block line, as the estimation value of the generated information amount of the block line.

In the same manner as that of the first embodiment, the target information amount setting unit 12 sets the value obtained by dividing the estimation value of the generated information amount of the leading picture by the refresh cycle as the target information amount of the intra slice in each picture within the refresh cycle. In addition, in the same manner as that of the first embodiment, the intra slice width setting unit 13 also may set the width and the position of the intra slice based on the estimation value of the generated information amount for each block line and the target information amount, for each picture within the refresh cycle.

According to the modification example, in the same manner as that of the second embodiment, the generated information amount estimation unit 11 may calculate the estimation value of the generated information amount of the region of the focusing picture corresponding to the unrefreshed region of the previous picture in the encoding sequence. In this case, the generated information amount estimation unit 11 may calculate the total sum of the encoding amounts or the SADs of the CU of the reduced picture corresponding to each CU included in the block line, for each block line, as the estimation value of the generated information amount of the block line. The generated information amount estimation unit 11 may calculate the total sum of the estimation values of the generated information amount of the each block line included in the region of the focusing picture corresponding to the unrefreshed region, as the estimation value of the generated information amount of the corresponding region.

In this case, the target information amount setting unit 12 may set the target information amount of the intra slice of the focusing picture by dividing the estimation value of the generated information amount of the region of the focusing picture corresponding to the region of the unrefreshed region of the previous picture by the remaining number of pictures of the refresh period.

The multiplexing unit 17 generates a stream including the encoding data of each picture obtained by the encoding unit 14 and the encoding data of each reduced picture obtained by the under layer encoding unit 16.

According to the embodiment, the generated information amount estimation unit 11 uses the encoding amount of the SAD calculated, when encoding the reduced picture which is generated from the focusing picture, for estimating the generated information amount of the focusing picture. Accordingly, the generated information amount estimation unit 11 can estimate the generated information amount accurately.

The apparatus for encoding a moving picture according to each of the above-described embodiments or the modifications may divide the each picture by a plurality of slices or a plurality of tiles. The apparatus for encoding a moving picture may set the width and the position of the intra slice of each picture for each slice or for each tile, according to any of the above-described embodiments or the modification examples.

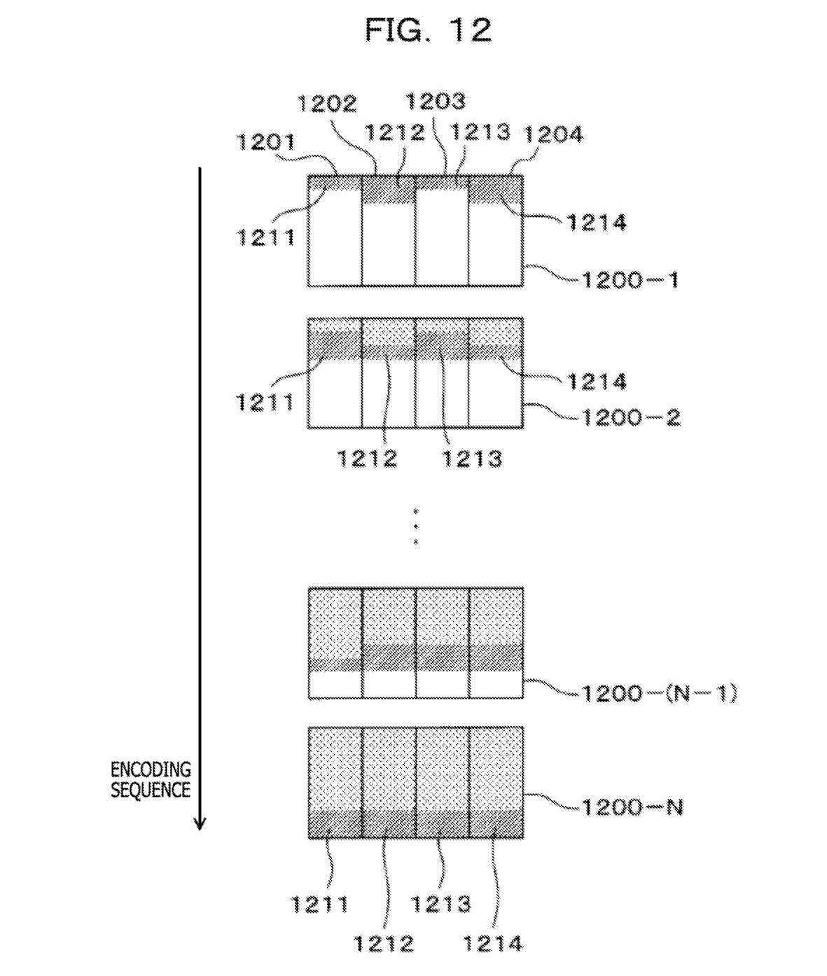

FIG. 12 is a diagram illustrating an example of the intra slice set in each picture within one refresh cycle according to the modification example. In FIG. 12, the vertical axis represents the encoding sequence. In this example, N pictures 1200-1 to 1200-N in the encoding sequence are included within the refresh cycle. Each picture is divided into four tiles 1201 to 1204, respectively. For each of the tiles 1201 to 1204, intra slices 1211 to 1214 are set. In each tile, the refresh cycle is the same. On the other hand, the position of the width of the slice may be different for each tile.

In addition, in the apparatus for encoding a moving picture to each of the above-described embodiments or the modifications, the refresh direction may be set to a horizontal direction.

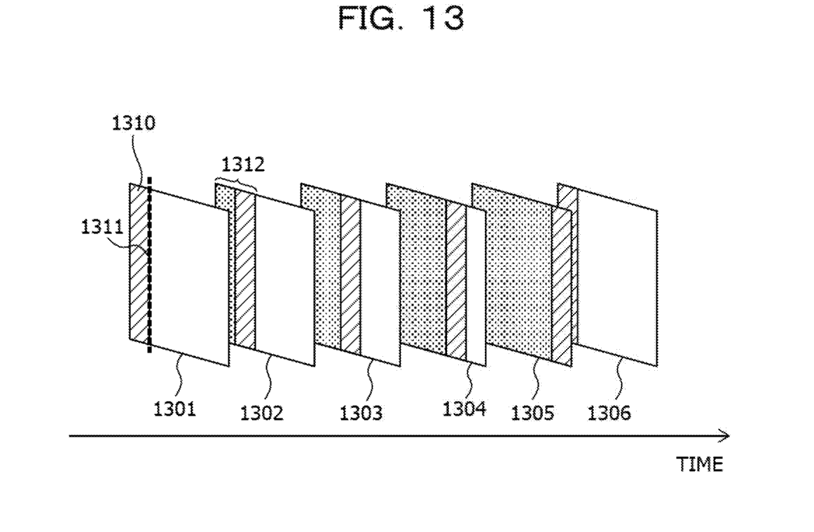

FIG. 13 is a diagram illustrating a case where the intra slice moves in a horizontal direction. In FIG. 13, the vertical axis represents the time. Each of pictures 1301 to 1306 is encoded as a P picture in which the inter prediction encoding mode referring only one direction is applicable or a B picture in which the inter prediction encoding mode in the both directions referring to only past picture is applicable. The apparatus for encoding a moving picture gradually shifts the position of the intra slice 1310 from left to right for each picture. The apparatus for encoding a moving picture causes the intra slice 1310 to travel the overall picture at the certain refresh cycle. Therefore, a region through which the intra slice 1310 is passed, in this example, the refreshed region 1312 that is a region right side than a refreshed boundary 1311 that is a right end of the intra slice 1310 is extended to the right side, with the lapse of time.

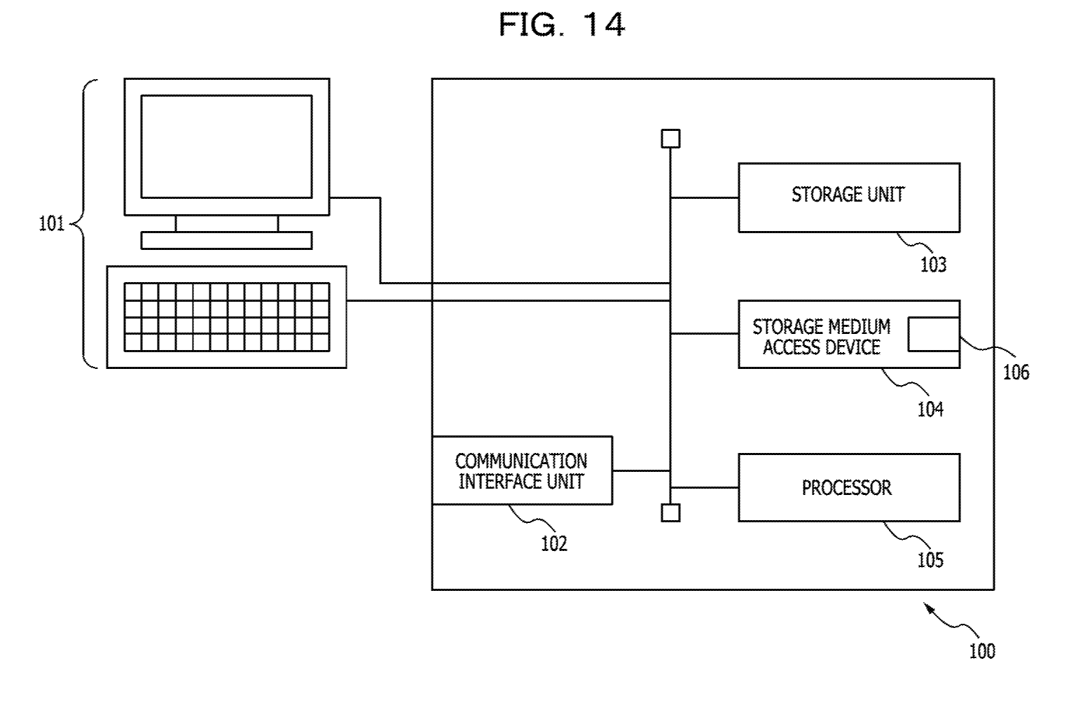

FIG. 14 is a configuration diagram of a computer operated as an apparatus for encoding moving picture by operating of a computer program for implementing the functionality of the various units of the apparatus for encoding a moving picture according to each embodiment or the modification examples thereof.

A computer 100 includes a user interface unit 101, a communication interface unit 102, a storage unit 103, a storage medium access device 104, and a processor 105. The processor 105 is coupled to the user interface unit 101, the communication interface unit 102, the storage unit 103, and the storage medium access device 104 through a bus for example.

The user interface unit 101 includes, for example, an input device such as a key board, a mouse, or the like and a display device such as a liquid display. Alternatively, the user interface unit 101 may include a device in which the input device and the display device are integrally formed, such as a touch panel display. For example, the user interface unit 101 outputs the operation signal for selecting the encoding a moving picture data to the processor 105 according to the operation of the user. In addition, the user interface unit 101 may display the decoded moving picture data which is received from the processor 105.

The communication interface unit 102 may include a communication interface for coupling the computer 100 to a device for generating the moving picture data, for example, a video camera and a control circuit thereof. For example, such a communication interface can adopt a universal serial bus (USB).

Furthermore, the communication interface unit 102 may include the communication interface for coupling to a communication network according to the communication standard such as the Ethernet (registered trademark) and the control circuit thereof.

In this case, the communication interface unit 102 acquires the encoding a moving picture data from the other equipments coupled to the communication network and transmits the data to the processor 105. In addition, the communication interface unit 102 may output the encoding a moving picture data received from the processor 105 to the other equipments through the communication network.

For example, the storage unit 103 includes a readable semiconductor memory and a read only semiconductor memory. The storage unit 103 is executed on the processor 105 and stores a computer program for executing the moving picture encoding process and data generated in middle of the process or generated as a result of the process.

For example, the storage medium access device 104 is a device that accesses a storage medium 106 such as a magnetic disk, a semiconductor memory card, and an optical storage medium. For example, the storage medium access device 104 reads the computer program for moving picture encoding processing to be executed on the processor 105 stored in the storage medium 106 and transmits the reading result to the processor 105.

The processor 105 executes the computer program for moving picture encoding processing by any one of the embodiments or the modification examples to generate the encoding a moving picture data. The processor 105 saves the generated encoding a moving picture data to the storage unit 103 or outputs the generated encoding a moving picture data to the other equipments through the communication interface unit 102. Examples of the processor 105 include a central processing unit (CPU), a micro processing unit (MPU), a field-programmable gate array (FPGA), or the like. The processor 105 may be a multi-processing unit mounting a plurality of processor cores and may be any of the processor cores mounted on the multi-processing unit.

A computer program executable on a processor to implement the function of each unit of the apparatus for encoding a moving picture 1 may be provided in the form recorded on a computer readable recording medium. The term “recording medium” here does not include a carrier wave.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An apparatus for encoding a moving picture data by an intra-refresh technique, the apparatus comprising:
a memory, and
a processor coupled to the memory and configured to:
perform setting of a width of an intra slice in each of a plurality of pictures included in the moving picture data within a refresh cycle having a given length such that a generated information amount in the intra slice is equalized between each of the plurality of pictures,
perform an intra-refresh to a region corresponding to the intra slice, and
perform encoding of each block included in a refreshed region, through which the intra slice is passed in the refresh cycle, by referring to an encoded pixel in the refreshed region of the picture or in the refreshed region of an encoded picture whose encoding sequential order is before that of the picture.

2. The apparatus according to claim 1,
wherein the processor is configured to
perform calculating of an estimation value of the generated information amount of an overall leading picture in the refresh cycle, and
perform calculating of a value obtained by dividing the estimation value of the generated information amount of the overall leading picture by the refresh cycle, as a target information amount relating to the intra slice of each picture, and
wherein the setting of the intra slice width includes
setting the width of the intra slice of the picture in a traveling direction so as to minimize a difference between the estimation value of the generated information amount of the intra slice of the picture and the target information amount, for each picture.

3. The apparatus according to claim 2,
wherein the calculating of the estimation value of the generated information amount includes
dividing the leading picture into a plurality of block lines which have a given width along the traveling direction and are extended in a direction perpendicular to the traveling direction,
calculating the estimation value of the generated information amount for each of the plurality of block lines, and
calculating a total sum of the estimation values of the generated information amounts of each of the plurality of block lines as the estimation value of the generated information amount of the overall leading picture.

4. The apparatus according to claim 3,
wherein the setting of the intra slice width includes
in the encoded picture of which the encoding sequence is immediately before with respect to the picture, sequentially accumulating the estimation value of the generated information amount every block line from a position of the picture corresponding to a boundary between the refreshed region and an unrefreshed region toward the traveling direction of the intra slice to calculate an accumulated sum of the estimation value, for each picture, and
setting a collective region of each block line corresponding to the accumulated sum, when the difference between the accumulated sum and the target information amount becomes minimized, to the intra slice for the picture.

5. The apparatus according to claim 4,
wherein the calculating of the estimation value of the generated information amount includes
calculating distributions of luminance brightness values of each pixel included in the block line for each of the plurality of block lines of the leading picture as the estimation value of the generated information amount of the block line.

6. The apparatus according to claim 3,
wherein the calculating of the estimation value of the generated information amount includes
when calculating the generated information amount for each of the plurality of block lines, using an evaluation value of the encoding amount of the block line, the block line being included in the intra slice of any of the encoded pictures included in a previous refresh cycle immediately before the refresh cycle and being in a position same as that of the block line to be set a calculation target of the generated information amount.

7. The apparatus according to claim 3,
wherein the processor is configured to
perform generating of a reduced picture by reducing the picture for each picture within the refresh cycle, and
perform encoding of the reduced picture corresponding to each picture within the refresh cycle, and
wherein the calculating of the estimation value of the generated information amount includes
calculating the generated information amount of the block line for each of the plurality of block lines based on the encoding amount of the region corresponding to the block line of the reduced picture corresponding to the leading picture.

8. The apparatus according to claim 1,
wherein the processor is configured to
perform calculating of the estimation value of the generated information amount of the corresponding region of the picture corresponding to an unrefreshed region in the picture of which the encoding sequence is immediately before the pictures, for a picture of the given order number from the leading within the refresh cycle, and
perform calculating of the value, which is obtained by dividing the estimation value of the generated information amount of the corresponding region by the number of pictures after the picture of the given order number in the refresh cycle, as the target information amount for the intra slice of the picture of the given order number, and
wherein the setting of the intra slice width includes
setting the width of the intra slice of the picture in a traveling direction for the picture of the given order number so as to minimize the difference between the estimation value of the generated information amount of the intra slice of the picture of the given order number and the target information amount.

9. The apparatus according to claim 8,
wherein the calculating of the estimation value of the generated information amount includes
calculating a total sum of the evaluation values of the encoding amount of each block included in an unrefreshed region in the encoded picture of which the encoding sequence is immediately before the pictures as the estimation value of the generated information amount of the corresponding region.

10. The apparatus according to claim 8,
wherein the calculating of the estimation value of the generated information amount includes
dividing the corresponding region into a plurality of block lines which have a given width along the traveling direction and are extended in a direction perpendicular to the traveling direction,
calculating the estimation value of the generated information amount for each of the plurality of block lines, and
calculating a total sum of the estimation values of the generated information amounts of each of the plurality of block lines as the estimation value of the generated information amount of the corresponding region.

11. The apparatus according to claim 10,
wherein the calculating of the estimation value of the generated information amount includes
when calculating the generated information amount for each of the plurality of block lines, using an evaluation value of the encoding amount of the block line, the block line being included in the intra slice of any of the encoded pictures included in a refresh cycle immediately before the refresh cycle and being in a position same as that of the block line to be set as a calculation target of the generated information amount.

12. The apparatus according to claim 10,
wherein the processor is configured to
perform generating of a reduced picture by reducing the picture for each picture within the refresh cycle, and
perform encoding of the reduced picture corresponding to each picture within the refresh cycle, and
wherein the calculating of the estimation value of the generated information amount includes
calculating the generated information amount of the block line for each of the plurality of block lines based on the encoding amount of the region corresponding to the block line of the reduced picture corresponding to the picture of the given order number.

13. The apparatus according to claim 1,
wherein the processor is configured to
perform calculating of the evaluation value of the encoding amount of the intra slice in the encoded picture of the given order number from the leading of a refresh cycle immediately before the refresh cycle for a picture of the given order number from the leading within the refresh cycle as a target information amount for the intra slice in the picture of the given order number, and
wherein the setting of the intra slice width includes
setting the width of the intra slice of the picture in a traveling direction for the picture of the given order number so as to minimize the difference between the estimation value of the generated information amount of the intra slice in the picture of the given order number and the target information amount.

14. A method for encoding a moving picture data by an intra-refresh technique, the method comprising:
setting a width of an intra slice in each of a plurality of pictures included in the moving picture data within a refresh cycle having a given length such that a generated information amount in the intra slice is equalized between each of the plurality of pictures;
performing an intra-refresh to a region corresponding to the intra slice; and
encoding each block included in a refreshed region, through which the intra slice is passed in the refresh cycle, by referring to an encoded pixel in the refreshed region of the picture or in the refreshed region of an encoded picture whose encoding sequential order is before that of the picture.

15. A non-transitory computer-readable medium for storing computer-executable program that cause a processor to execute a process, the process comprising:
setting a width of an intra slice in each of a plurality of pictures included in the moving picture data within a refresh cycle having a given length such that a generated information amount in the intra slice is equalized between each of the plurality of pictures;
perform an intra-refresh to a region corresponding to the intra slice; and
encoding each block included in a refreshed region, through which the intra slice is passed in the refresh cycle, by referring to an encoded pixel in the refreshed region of the picture or in the refreshed region of an encoded picture whose encoding sequential order is before that of the picture.
